(19) United States
(12) Patent Application Publication
(10) Pub. No.: US 2026/0012575 A1
(43) Pub. Date: Jan. 8, 2026

(54) METHODS FOR PREDICTING CODING UNIT USING DUAL MERGE PREDICTION MODE

(71) Applicant: Alibaba (China) Co., Ltd., Hangzhou (CN)

(72) Inventors: Ru-ling LIAO, Sunnyvale, CA (US); Yan YE, San Diego, CA (US); Jie CHEN, Beijing (CN); Xinwei LI, Beijing (CN)

(21) Appl. No.: 19/246,005

(22) Filed: Jun. 23, 2025

Related U.S. Application Data
(60) Provisional application No. 63/667,667, filed on Jul. 3, 2024.

(51) Int. Cl. H04N 19/105; H04N 19/176; H04N 19/52

(52) U.S. Cl. CPC H04N 19/105; H04N 19/176; H04N 19/52

(57) ABSTRACT

The present disclosure provides a method for encoding a video sequence. The method includes: receiving a video sequence; and encoding the video sequence by: constructing a merge candidate list for a current block; obtaining a first set of motion information and a second set of motion information from the merge candidate list; performing a first motion compensation and a second motion compensation with the first set of motion information and the second set of motion information respectively; generating a first prediction and a second prediction based on the first motion compensation and the second motion compensation respectively; and generating a final prediction of the current block by weighting the first prediction and the second prediction.

### CROSS-REFERENCE TO RELATED APPLICATIONS

This disclosure claims the benefits of priority to U.S. Provisional Application No. 63/667,667, filed on Jul. 3, 2024, which is incorporated herein by reference in its entirety.

### TECHNICAL FIELD

The present disclosure generally relates to video processing, and more particularly, to methods and a non-transitory computer-readable storage medium for predicting a coding unit using dual merge prediction mode.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCL0 SURE

Embodiments of the present disclosure provide a method for encoding a video sequence. In some embodiments, the method includes: receiving a video sequence; and encoding the video sequence by: constructing a merge candidate list for a current block; obtaining a first set of motion information and a second set of motion information from the merge candidate list; performing a first motion compensation and a second motion compensation with the first set of motion information and the second set of motion information respectively; generating a first prediction and a second prediction based on the first motion compensation and the second motion compensation respectively; and generating a final prediction of the current block by weighting the first prediction and the second prediction.

Embodiments of the present disclosure provide a method for decoding a bitstream. In some embodiments, the method includes: receiving a bitstream; and decoding the bitstream to output a video sequence. The decoding includes: constructing a merge candidate list for a current block; obtaining a first set of motion information and a second set of motion information from the merge candidate list; performing a first motion compensation and a second motion compensation with the first set of motion information and the second set of motion information respectively; generating a first prediction and a second prediction based on the first motion compensation and the second motion compensation respectively; and generating a final prediction of the current block by weighting the first prediction and the second prediction.

Embodiments of the present disclosure provide a non-transitory computer readable medium storing a bitstream, the bitstream generated by receiving a video sequence, encoding the video sequence to generate coded information included in the bitstream, and transmit the bitstream. The encoding includes: constructing a merge candidate list for a current block; obtaining a first set of motion information and a second set of motion information from the merge candidate list; performing a first motion compensation and a second motion compensation with the first set of motion information and the second set of motion information respectively; generating a first prediction and a second prediction based on the first motion compensation and the second motion compensation respectively; and generating a final prediction of the current block by weighting the first prediction and the second prediction.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 illustrates exemplary positions of spatial merge candidates, according to some embodiments of the present disclosure.

FIG. 6 illustrates exemplary candidate pairs considered for redundancy check of spatial merge candidates, according to some embodiments of the present disclosure.

FIG. 7 illustrates an exemplary motion vector scaling for temporal merge candidate, according to some embodiments of the present disclosure.

FIG. 8 illustrates exemplary candidate positions for temporal merge candidate, according to some embodiments of the present disclosure.

FIG. 9 illustrates exemplary spatial neighboring blocks used to derive the spatial merge candidates, according to some embodiments of the present disclosure.

FIG. 10 is a schematic diagram illustrating an exemplary merge mode.

FIG. 11 is a schematic diagram illustrating an exemplary framework for dual merge prediction mode, according to some embodiments of the present disclosure.

FIG. 12 is a flowchart illustrating an exemplary method of a dual merge prediction mode, according to some embodiments of the present disclosure.

FIG. 13 illustrates an example flow chart of a method for signaling a CU-level dual merge flag, according to some embodiments of the present disclosure.

FIG. 14 illustrates an exemplary flag signaling tree for signaling flags in syntax structure consistent with FIG. 13, according to some embodiments of the present disclosure.

FIG. 15 illustrates another exemplary flag signaling tree for signaling flags in syntax structure, according to some embodiments of the present disclosure.

FIG. 16 illustrates another exemplary flag signaling tree for signaling flags in syntax structure, according to some embodiments of the present disclosure.

FIG. 17 illustrates exemplary codes of pairing candidates to form dual merge candidate, according to some embodiments of the present disclosure.

FIG. 18 illustrates exemplary codes of pairing candidates to form dual merge candidates, according to some embodiments of the present disclosure.

FIG. 19 is a schematic diagram illustrating an exemplary framework of combining dual merge prediction mode with other inter tools, according to some embodiments of the present disclosure.

FIG. 20 illustrates an example flow chart of a method 2000 for selectively storing motion information, according to some embodiments of the present disclosure.

FIG. 21 is a schematic diagram illustrating an exemplary selection process of motion information storage, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEEVC.

The VVC standard has been developed recently, and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

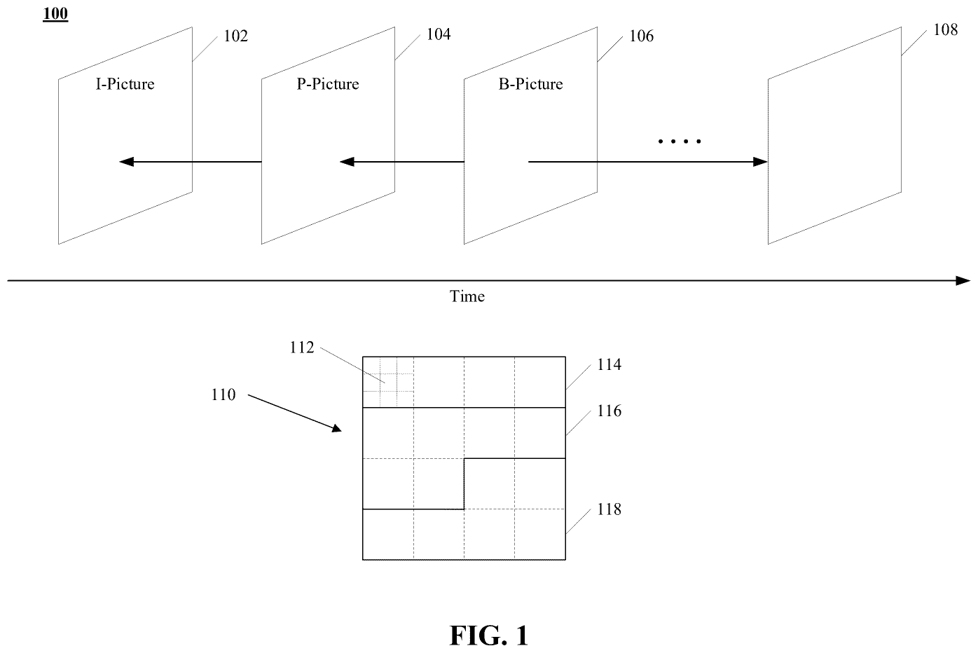

FIG. 1 illustrates structures of an exemplary video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

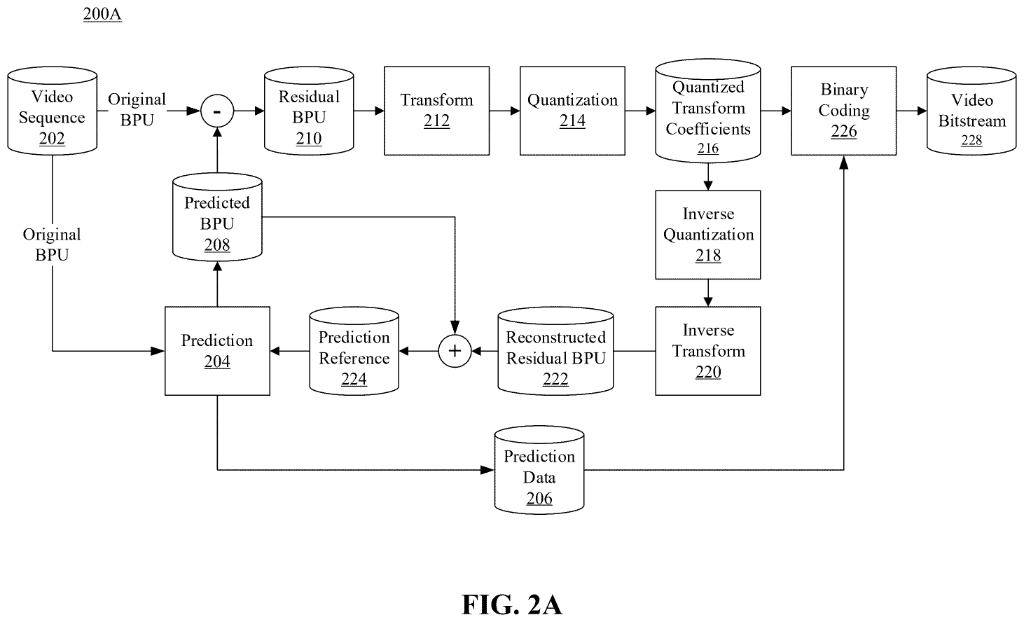

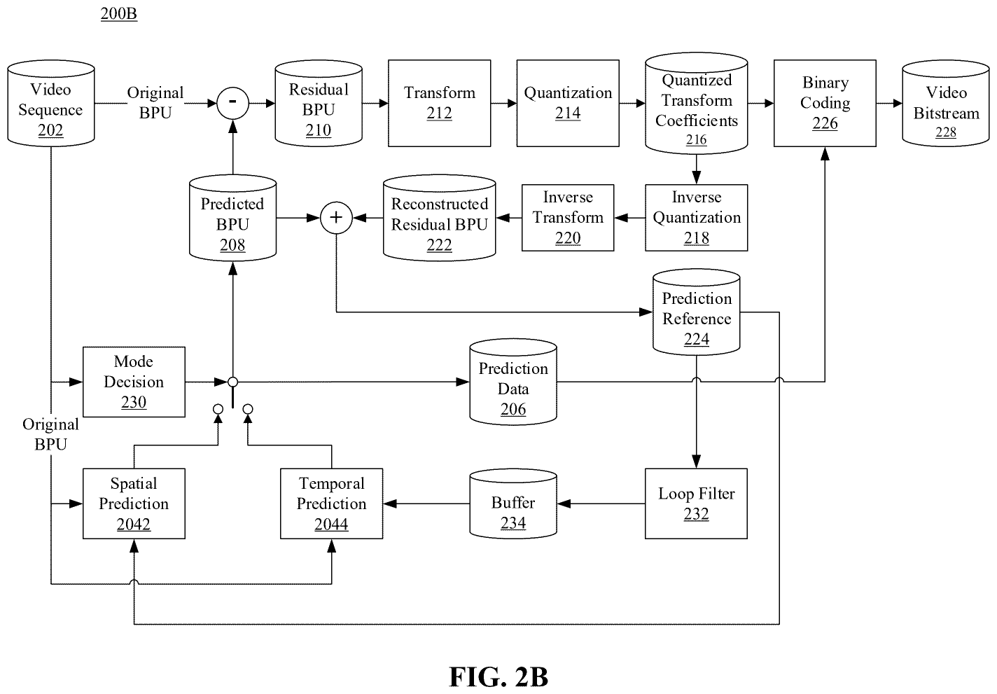

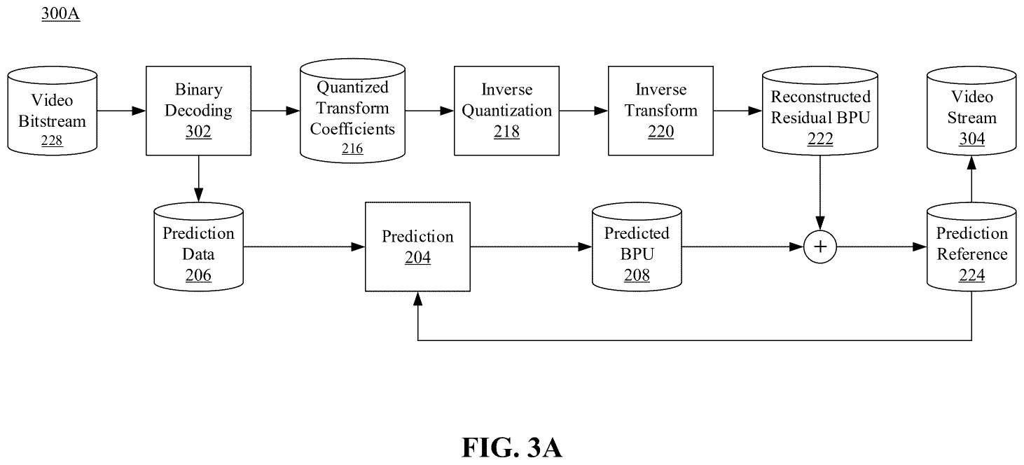

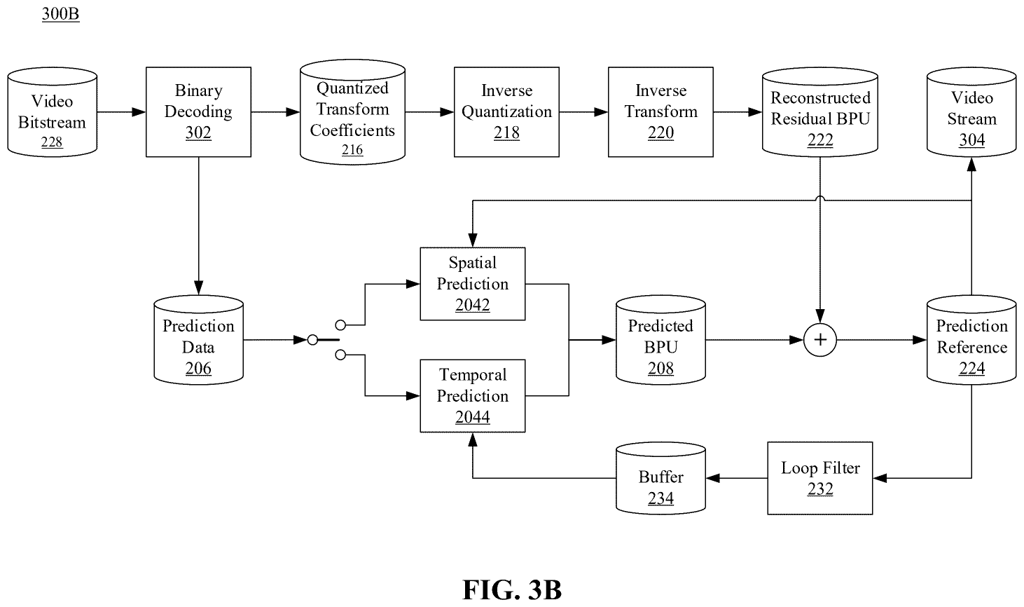

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIG. 2A and FIG. 2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization syntax element or any other syntax element of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, syntax elements of the prediction operation, a transform type at transform stage 212, syntax elements of the quantization process (e.g., quantization syntax elements), an encoder control syntax element (e.g., a bitrate control syntax element), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, syntax elements of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer (DPB)”) for later use (e.g., to be used as an inter-prediction reference picture for a future picture of video sequence 202). The encoder can store one or more reference pictures in buffer 234 to be used at temporal prediction stage 2044. In some embodiments, the encoder can encode syntax elements of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIG. 2A and FIG. 2B), generally, video stream 304 is not identical to video sequence 202. Similar to processes 200A and 200B in FIG. 2A and FIG. 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, syntax elements of the prediction operation, a transform type, syntax elements of the quantization process (e.g., quantization syntax elements), an encoder control syntax element (e.g., a bitrate control syntax element), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, syntax elements of the intra prediction operation, or the like. The syntax elements of the intra prediction operation can include, for example, locations (e.g., coordinates) of one or more neighboring BPUs used as a reference, sizes of the neighboring BPUs, syntax elements of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, syntax elements of the inter prediction operation, or the like. The syntax elements of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer (DPB) in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include syntax elements of the loop filter (e.g., a loop filter strength). In some embodiments, prediction data includes syntax elements of the loop filter when the prediction mode indicator of prediction data 206 indicates that inter prediction was used to encode the current BPU.

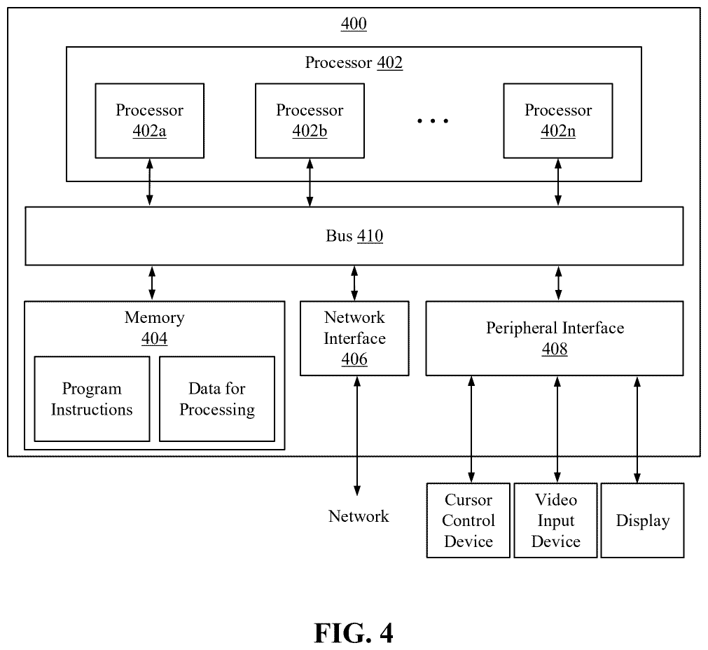

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

After the VVC standard is finalized and published as an international standard, the JVET starts exploring new coding tools to further improve the coding performance of the VVC standard. An Enhanced Compression Model (ECM) has been proposed and used as a new software base for developing tools beyond the VVC standard.

In VVC, the merge candidate list can be constructed by including the following five types of candidates in order:
(1) Spatial MVP (Motion Vector Prediction) from spatial neighbour CUs;
(2) Temporal MVP from collocated CUs (hereinafter referred to as TMVP);
(3) History-based MVP from an FIFO (First in first out) table;
(4) Pairwise average MVP; and
(5) Zero MVs (Motion Vectors).

The size of merge list can be signaled in a sequence parameter set header and the maximum allowed size of merge list is 6. For each CU code in merge mode, an index of best merge candidate is encoded using truncated unary binarization (TU). The derivation process of each category of merge candidates is provided in this session. As done in HEVC, VVC also supports parallel derivation of the merging candidate lists for all CUs within a certain size of area.

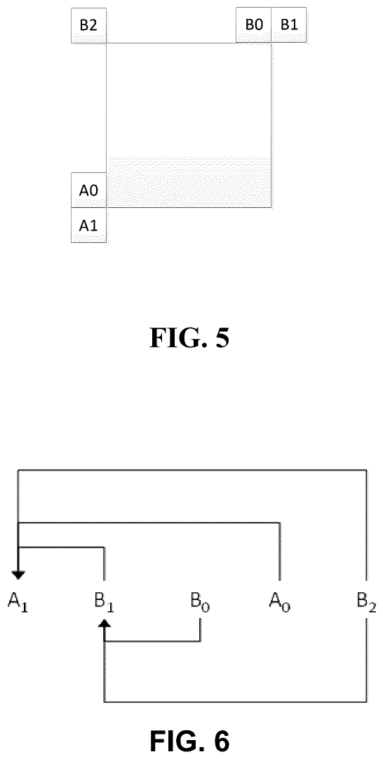

Next, spatial candidates derivation used in the disclosed embodiments is described. The derivation of spatial merge candidates in VVC is the same to that in HEVC except for the positions of first two merge candidates are swapped. FIG. 5 illustrates exemplary positions of spatial merge candidates, according to some embodiments of the present disclosure. A maximum of four merge candidates are selected among candidates located in the positions as shown in FIG. 5. The order of derivation is B0, A0, B1, A1 and B2. Position B2 is considered only when one or more CUs of position B0, A0, B1, A1 are not available (e.g. because the position belongs to another slice or tile) or is intra coded. After the candidate at position A1 is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 6 illustrates exemplary candidate pairs considered for redundancy check of spatial merge candidates, according to some embodiments of the present disclosure. As shown in FIG. 6, only the pairs linked with an arrow in FIG. 6 are considered and a candidate is only added to the list if the corresponding candidate used for redundancy check has not the same motion information.

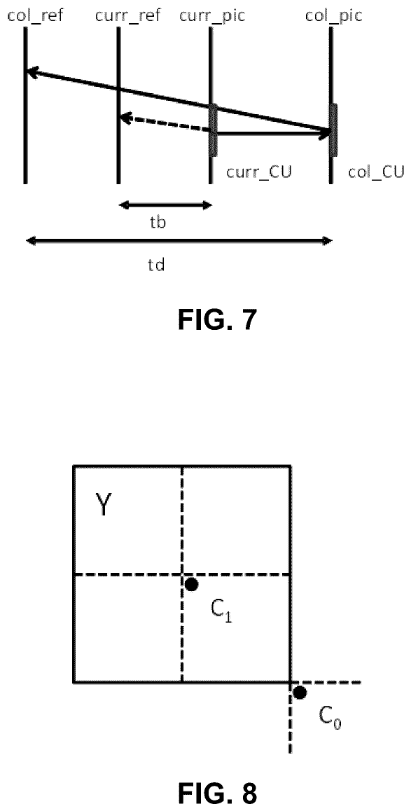

Next, temporal candidates derivation used in the disclosed embodiments is described. In this step, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signaled in the slice header. FIG. 7 illustrates an exemplary motion vector scaling for temporal merge candidate, according to some embodiments of the present disclosure. The scaled motion vector for temporal merge candidate is obtained as illustrated by the dotted line in FIG. 7, which is scaled from the motion vector of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

It is noted that when deriving a temporal merge candidate, the scaled motion vector can be derived from one of motion of the co-located CU, wherein the one of motion of the co-located CU is determined according to the following rules:
1. If the motion of the co-located CU is a bi-predicted motion and the current picture is a low delay picture, the L0 motion of the TMVP is scaled from the L0 motion of the co-located CU and the L1 motion of the TMVP is scaled from the L1 motion of the co-located CU.
2. Otherwise, if the motion of the co-located CU is a bi-predicted motion and the current picture is a non-low delay picture, which one of the two motion of the co-located CU is used to perform scaling is determined according to the reference picture list of the co-located CU. More specifically, if the co-located CU is from the L0 reference picture list, the L0 and L1 motion of the TMVP are both scaled from the L1 motion of the co-located CU. Similarly, if the co-located CU is from the L1 reference picture list, the L0 and L1 motion of the TMVP are both scaled from the L0 motion of the co-located CU.
3. Otherwise, if the motion of the co-located CU is a L0-predicted motion, the L0 and L1 motion of the TMVP are both scaled from the L0 motion of the co-located CU no matter whether the current picture is a low-delay picture or not. Similarly, if the motion of the co-located CU is an L1-predicted motion, the L0 and L1 motion of the TMVP are both scaled from the L1 motion of the co-located CU.

FIG. 8 illustrates exemplary candidate positions for temporal merge candidate, according to some embodiments of the present disclosure. The position for the temporal candidate can be selected between candidates C0 and C1, as depicted in FIG. 8. If CU at position C0 is not available, is intra coded, or is outside of the current row of CTUs, position C1 is used. Otherwise, position C0 is used in the derivation of the temporal merge candidate.

Next, history-based merge candidates derivation used in the disclosed embodiments is described. The history-based MVP (HMVP) merge candidates can be added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is first applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications can be introduced: The last two entries in the table are redundancy checked to A1 and B1 spatial candidates, respectively. Once the total number of available merge candidates reaches the maximally allowed merge candidates minus 1, the merge candidate list construction process from HMVP is terminated.

Next, pair-wise average merge candidates derivation used in the disclosed embodiments is described. Pairwise average candidates can be generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; if no motion vector is available, keep this list invalid. Also, if the half-pel interpolation filter indices of p0Cand and p1Cand are different, it is set to 0.

Next, zero motion used in the disclosed embodiments is described. When the merge list is not full after pair-wise average merge candidates are added, the zero MVPs are inserted in the end until the maximum merge candidate number is encountered.

Next, merge list construction in ECM used in the disclosed embodiments is described. In ECM, the maximum number of merge candidate list is extended up to 15. Besides, the merge candidate list is constructed by including the following types of candidates:
(1) Spatial MVP from spatial neighbor CUs;
(2) Temporal MVP from collocated CUs;
(3) Non-adjacent spatial candidates;
(4) History-based MVP from an FIFO table;
(5) Chained motion vector prediction;
(6) Pairwise average MVP;
(7) Non-local illumination compensation (NLIC) candidates; and
(8) Zero MVs.

Besides, after the merge candidate list is constructed, the merge candidates can be reordered (hereinafter referred to as ARMC) according to a template matching cost (TM cost). The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

In the reordering process (also known as, diversity ARMC), a candidate is considered as redundant if the cost difference between a candidate and its predecessor is inferior to a lambda value e.g. |D1−D2|<λ, where D1 and D2 are the costs obtained during the first ARMC ordering and λ is the Lagrangian parameter used in the RD criterion at the encoder side.

The proposed algorithm is defined as the following:

Determine the minimum cost difference between a candidate and its predecessor among all candidates in the list:
If the minimum cost difference is superior or equal to λ, the list is considered diverse enough and the reordering stops;
If this minimum cost difference is inferior to λ, the candidate is considered as redundant, and it is moved at a further position in the list. This further position is the first position where the candidate is diverse enough compared to its predecessor.

The algorithm stops after a finite number of iterations (if the minimum cost difference is not inferior to λ).

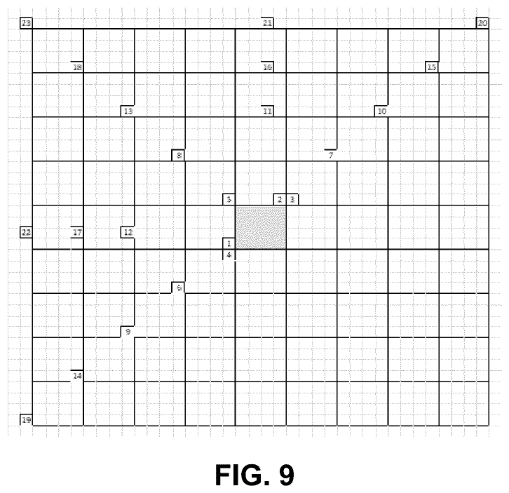

Non-adjacent spatial merge candidates used in the disclosed embodiments is described. The non-adjacent spatial merge candidates can be inserted after the TMVP in the regular merge candidate list. FIG. 9 illustrates exemplary spatial neighboring blocks used to derive the spatial merge candidates, according to some embodiments of the present disclosure. The pattern of spatial merge candidates is shown in FIG. 9. The distances between non-adjacent spatial candidates and current coding block are based on the width and height of current coding block. The line buffer restriction is not applied.

Next, chained motion vector prediction (CMVP) used in the disclosed embodiments is described. The chained motion vector prediction candidates are introduced as one of merge candidates, and are inserted after HMVP candidates for regular merge and TM merge modes. The CMVP shares a similar idea with auto-relocated block vector prediction, and CMVP candidates are derived as the accumulation of the recursively traced MVs and BVs (block vectors) based on the pre-derived MVs. In the current design, CMVP candidates can be derived for each merge index and each reference picture list. The traceable reference pictures are restricted to the reference pictures in the reference picture list.

Next, non-local illumination compensation (NLIC) used in the disclosed embodiments is described. Non-local illumination compensation (NLIC) can be applied in ECM wherein the linear model is derived from the previously coded inter CUs by minimizing the difference between their reconstruction and prediction samples. When constructing the merge lists, additional 16 and 6 NLIC candidates (obtained from both spatial adjacent and non-adjacent positions) are inserted into the lists of regular merge and subblock merge respectively, and reordered with the existing merge candidates. The lengths of the output merge lists are kept unchanged. The same pattern used for non-adjacent merge mode is reused to locate the non-adjacent positions in the scheme.

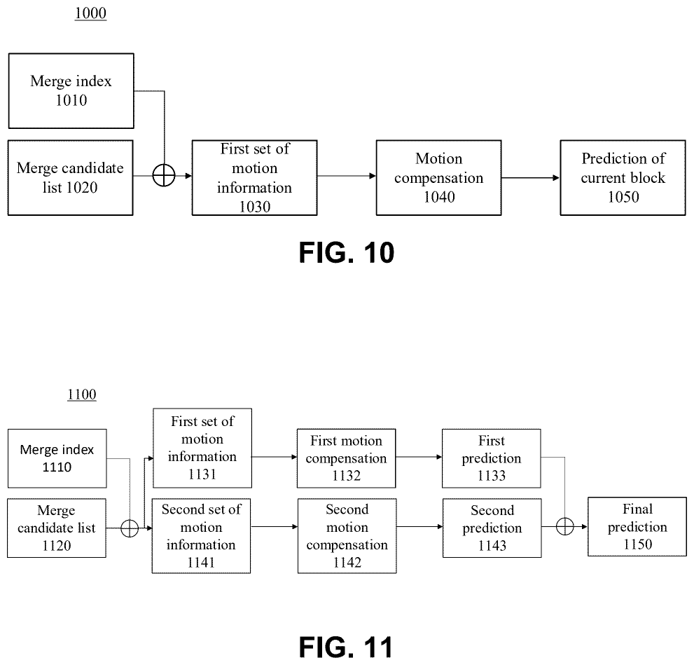

Conventional designs for merge mode only allow to inherit motion information from one neighboring block. That is, when a merge candidate list is constructed, only one index is signaled to indicate which one of merge candidates is used to predict the current block. FIG. 10 is a schematic diagram illustrating an exemplary merge mode 1000. As shown in FIG. 10, only merge index 1010 is signaled to indicate which one of merge candidate in merge candidate list 1020 is used to obtain a set of motion information 1030 for motion compensation 1040 and prediction of current block 1050. This may limit the prediction efficiency of merge mode.

In some embodiments of the present disclosure, it is proposed to allow inherit motion information from a plurality of neighboring blocks. More specifically, a dual merge prediction mode is proposed.

FIG. 11 is a schematic diagram illustrating an exemplary framework 1100 for dual merge prediction mode, according to some embodiments of the present disclosure. As shown in FIG. 11, a first set of motion information 1131 and a second set of motion information 1141 are derived from a merge candidate list 1120. Then, a first motion compensation 1132 and a second motion compensation 1142 are performed with each set of first motion information 1131 and second motion information 1141, and a first prediction 1133 and a second prediction 1143 are generated respectively. Finally, first prediction 1133 and second prediction 1143 are fused together to generate a final prediction 1150 of a current block.

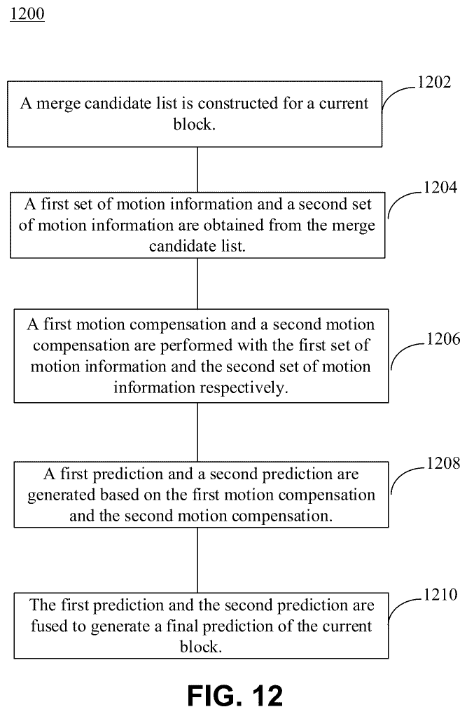

FIG. 12 illustrates an example flow chart of a method 1200 of dual merge prediction mode, according to some embodiments of the present disclosure. Method 1200 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1200. In some embodiments, method 1200 can be implemented by a computer program product, embodied in a computer-readable medium, including computer-executable instructions, such as program code, executed by computers (e.g., apparatus 400 of FIG. 4). Referring to FIG. 12 and in consistent with FIG. 11, method 1200 may include the following steps 1202-1210.

At step 1202, a merge candidate list is constructed for a current block.

At step 1204, a first set of motion information and a second set of motion information are obtained from the merge candidate list. In some embodiments, a set of motion information, e.g., first set of motion information 1131 and second set of motion information 1141, can be uni-predicted or bi-predicted motion information. For example, a set of motion information may contain reference picture indices to the two reference picture lists L0 and L1, motion vectors, bi-predicted with CU-level weight index (BCW index), local illumination compensation flag (LIC flag), LIC parameters, half-pel interpolation flag (half-pel flag), multi-hypothesis prediction information (MHP), etc.

At step 1206, a first motion compensation and a second motion compensation are performed with the first set of motion information and the second set of motion information respectively.

At step 1208, a first prediction and a second prediction are generated based on the first motion compensation and the second motion compensation respectively.

At step 1210, the first prediction and the second prediction are fused to generate a final prediction of the current block. In some embodiments, the final prediction is obtained by the following equation:

$$P r e {d}_{final} ( x , y ) = w 0 \times P r e {d}_{1 s t} ( x , y ) + w 1 \times P r e {d}_{2 nd} ( x , y )$$

where (x, y) are the sample position (coordinates) in the current block, Pred_{final} is the final prediction of the current block. Pred₁ₛₜ and Pred_{2nd} are the two predictions generated by the two sets of motion information, and w0 and w1 are the weights applied to the two prediction blocks.

In some embodiments, the value of w0 can be set equal to w1. That is, a simple average is applied.

In some embodiments, the value of w0 can be set not equal to w1. That is, a weighted average is applied. In some embodiments, the sum of w0 and w1 can be restricted to be 1, and both w0 and w1 are not equal to 0.

In some embodiments, the w0 and w1 can be derived using TM cost. The w0 and w1 can also be signaled in the bitstream.

In some embodiments, the dual merge prediction mode is enabled at a high-level. For example, a high-level flag indicating whether a dual merge prediction mode is enabled or not is signaled in in Sequence Parameter Set (i.e., at SPS-level), Sequence Parameter Set (i.e., at PPS-level), picture header or slice header.

In some embodiments, whether to enable dual merge prediction mode at a high-level, for example, for a current picture or a current slice, can be derived according to an enabled area of dual merge prediction mode of previous coded picture instead of signaling a flag in the bitstream. For example, whether the dual merge prediction mode is used or not for previous pictures in the same sequence is determined, in response to a ratio the previous pictures coded using the dual merge prediction mode being greater than a threshold, for example, 10%, the dual merge prediction mode is enabled for the current picture or slice. In some embodiments, the ratio is calculated based on the number of pictures, i.e., comparing a number of the picture coded using the dual merge prediction mode with a total number of the previous coded pictures in the same sequence.

In some embodiments, whether to enable dual merge prediction mode at a high-level, for example, for a current picture or a current slice can be derived according to a temporal layer of the current picture or the current slice. For example, one sequence may include multiple temporal layers (TLayers, TL), for example, 6 temporal layers. A picture or a slice belongs to one temporal layer, and an index of the temporal layer (i.e., temporal id) is used to indicate an index of the temporal layer of the current picture or slice. Whether the dual merge prediction mode is enabled or not for current picture or slice is determined based on the index of the temporal layer. Specifically, if the index of the temporal layer of the current picture or slice is less than a threshold, the dual merge prediction mode is enabled for the current picture or slice. In some embodiments, when the index of the temporal layer of the current picture or slice is less than 3, i.e., the temporary id is one of 0, 1, 2, the dual merge prediction mode is determined to be enabled for the current picture or slice.

Some embodiments of the present disclosure provide methods for prediction coding unit using dual merge prediction mode.

In some embodiments, the dual merge prediction mode is proposed as a new merge mode, and whether the dual merge prediction mode is enabled at CU-level is determined in an explicit way by signaling a flag indicating whether the dual merge prediction mode is enabled. The CU-level flag is signaled when the current block is coded as skip or merge mode. In some embodiments, the dual merge prediction mode flag can be signaled in different positions in the skip or merge syntax structure.

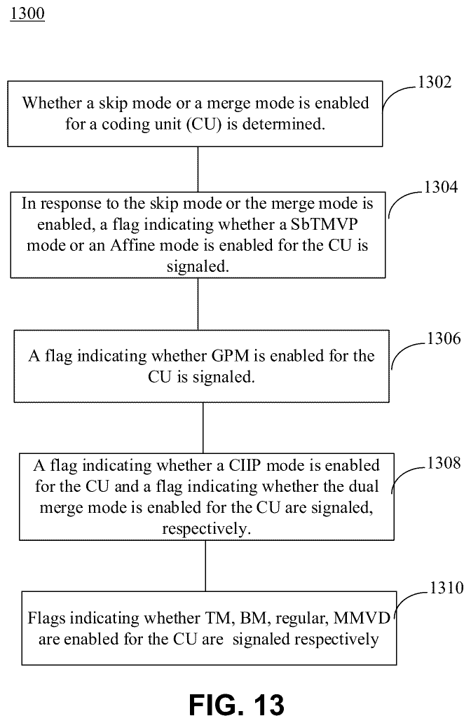

FIG. 13 illustrates an example flow chart of a method 1300 for signaling a CU-level dual merge flag, according to some embodiments of the present disclosure. Method 1300 can be performed by an encoder (e.g., by process 200A of FIG. 2A or 200B of FIG. 2B), or performed by one or more software or hardware components of an apparatus (e.g., apparatus 400 of FIG. 4). For example, a processor (e.g., processor 402 of FIG. 4) can perform method 1300. In some embodiments, method 1300 can be implemented by a computer program product, embodied in a computer-readable medium, including computer-executable instructions, such as program code, executed by computers (e.g., apparatus 400 of FIG. 4). Referring to FIG. 13, method 1300 may include the following steps 1302-1310.

At step 1302, whether a skip mode or a merge mode is enabled for a coding unit (CU) is determined.

At step 1304, in response to the skip mode or the merge mode is enabled, a flag indicating whether a subblock-based temporal motion vector prediction (SbTMVP) mode or an Affine mode is enabled for the CU is signaled.

At step 1306, a flag indicating whether geometric partitioning mode (GPM) is enabled for the CU is signaled.

At step 1308, a flag indicating whether a combined inter and intra prediction (CIIP) mode is enabled for the CU and a flag indicating whether the dual merge prediction mode is enabled for the CU are signaled, respectively.

At step 1310, flags indicating whether template matching (TM), bilateral matching (BM), regular, merge mode with motion vector difference (MMVD) are enabled for the CU are signaled respectively.

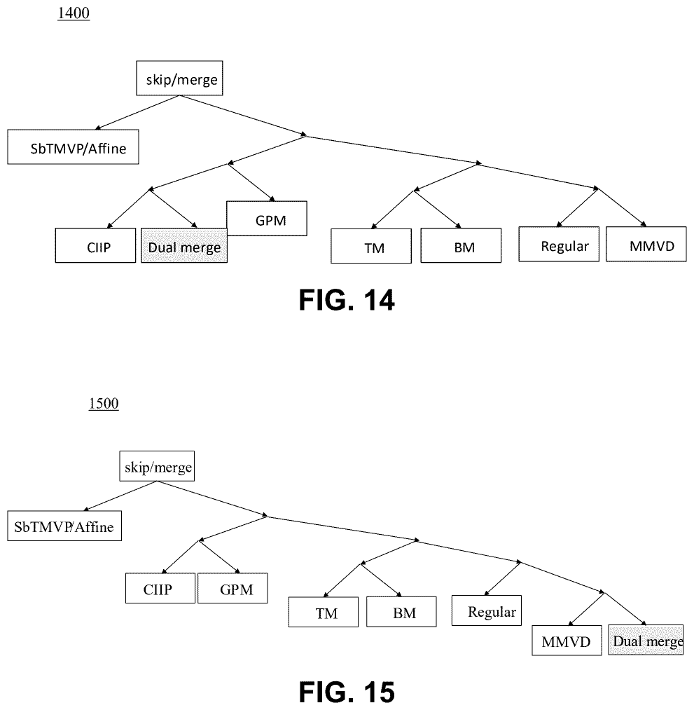

FIG. 14 illustrates an exemplary flag signaling tree 1400 for signaling flags in syntax structure consistent with FIG. 13, according to some embodiments of the present disclosure. As shown in FIG. 14, a flag indicating whether the dual merge prediction mode enabled for a CU is signaled when a flag indicating whether the CIIP mode is enabled for the CU is signaled.

FIG. 15 illustrates another exemplary flag signaling tree 1500 for signaling flags in syntax structure, according to some embodiments of the present disclosure. As shown in FIG. 15, the flag indicating whether the dual merge prediction mode enabled for a CU is signaled when a flag indicating whether MMVD mode is enabled for the CU is signaled. Specifically, a flag indicating whether a skip or a merge mode is enabled for the CU is signaled. In response to the skip mode or the merge mode is enabled, signaling a flag indicating whether a SbTMVP mode or an Affine mode is enabled for the CU. Then flags indicating whether CIIP and GPM modes are enabled for the CU are signaled respectively. Then flags indicating whether TM and BM modes are enabled for the CU are signaled respectively. Then, a flag indicating whether Regular mode is enabled for the CU is signaled. Finally, flags indicating whether MMVD and dual merge prediction modes are enabled for the CU are signaled respectively.

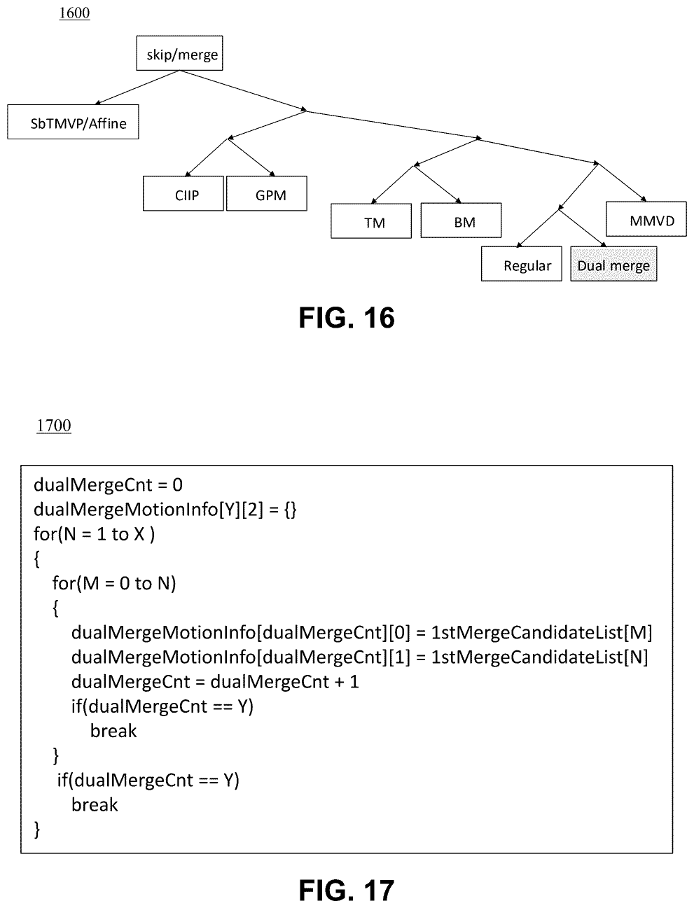

FIG. 16 illustrates another exemplary flag signaling tree 1600 for signaling flags in syntax structure, according to some embodiments of the present disclosure. As shown in FIG. 16, the flag indicating whether the dual merge prediction mode enabled for a CU is signaled when a flag indicating whether Regular mode is enabled for the CU is signaled. Specifically, a flag indicating whether a skip or a merge mode is enabled for the CU is signaled. In response to the skip mode or the merge mode is enabled, signaling a flag indicating whether a SbTMVP mode or an Affine mode is enabled for the CU. Then flags indicating whether CIIP and GPM modes are enabled for the CU are signaled respectively. Then flags indicating whether TM and BM modes are enabled for the CU are signaled respectively. Then, flags indicating whether Regular and dual merge prediction modes are enabled for the CU are signaled respectively. Finally, a flag indicating whether MMVD mode is enabled for the CU is signaled.

In some embodiments, the CU-level dual merge flag is signaled only when the block size of the coding unit is larger than a pre-defined threshold. In one example, the dual merge flag is signaled when both width and height of a block is larger than or equal to N, where N is a positive integer. In some embodiments, N is 16. In another example, the dual merge flag is signaled when width×height of a block is larger than or equal to M luma samples, where M is a positive integer. In some embodiments, M is 256. In others example, the dual merge flag is signaled when both width and height of a block is larger than or equal to N and width×height is larger than or equal to M luma samples.

Some embodiments of the present disclosure provide method for constructing the dual merge candidate list.

In some embodiments, each merge candidate in the dual merge candidate list contains exactly one set of motion information. The dual merge candidate list can be constructed using one of the list construction processes of regular merge mode, template matching (TM) merge mode, bilateral matching (BM) merge mode, merge with MVD (MMVD) mode, geometric partition mode (GPM), or combined inter and intra prediction (CIIP) mode. Then, two merge indices, i.e., a first merge index and a second merge index, are signaled to indicate which two merge candidates are used to generate the two predictions. The first merge index is different from the second merge index.

In some embodiments, to reduce the redundant combination, restrictions are applied to the two merge indices. In one example, the second merge index is larger than the first merge index. For example, there are total X merge candidates, the value of the first merge index M can be 0 to X−2, and the value of the second merge index N can be M+1 to X−1. In another example, the second merge index is smaller than the first merge index. For example, there are total X merge candidates, the value of the first merge index M can be 1 to X−1, and the value of the second merge index N can be 0 to M−1.

In some embodiments, each merge candidate in the dual merge candidate list contains two sets of motion information. Then, one merge index is signaled to indicate which merge candidate containing two sets of motion information is used to predict the current block.

In some embodiments, a first candidate list is constructed using one of the list construction processes of regular, TM, BM, MMVD, GPM or CIIP mode. Each candidate in the first candidate list may only contain one set of motion information. Then, the dual merge candidate list is constructed by pairing candidates in the first candidate list. FIG. 17 illustrates exemplary codes 1700 of pairing candidates to form dual merge candidate, according to some embodiments of the present disclosure, where:
1stMergeCandidateList is used to store motion information and merge candidates of the first candidate list;
X is the number of merge candidates in the first candidate list;
Y is a pre-defined value that indicates the maximum number of dual merge candidates;
dualMergeMotionInfo is used to store dual merge candidates and each dual merge candidate has two sets of motion information.

In some embodiments, the dual merge candidate list is filled with dual merge candidates from neighboring blocks. More specifically, if a neighboring block is coded using dual merge prediction mode, two sets of motion information of the neighboring block are copied and inherited as one of dual merge candidate of the current block. The neighboring block may be spatial neighboring block, non-adjacent spatial neighboring block, temporal collocated blocks, HMVP, etc. In response to the dual merge candidate list filled with the dual merge candidates from neighboring block is not full, i.e., a number of the candidate is less than Y, a first candidate list is constructed using one of the list construction processes of regular, TM, BM, MMVD, GPM or CIIP mode. Then, candidates in the first candidate list are paired and added to the dual merge candidate list. In some embodiments, ARMC or diversity ARMC process may be applied to adaptively reordering all dual merge candidate in the dual merge candidate list.

In some embodiments, when constructing the first candidate list, construction processes different from the existing ones can be used. In some embodiments, the diversity ARMC or ARMC is not applied to reorder the candidates in the first candidate list. In some embodiments, the NLIC candidates are not added to the first candidate list. In some embodiments, the pruning threshold for motion vector used in the list construction can be adaptively adjusted according to block size. For example, the block size is larger, the threshold is greater. In some embodiments, when the block size is smaller than 64, the threshold is set as 1, and when the block size is greater than or equal to 64, the threshold is set as 4.

In some embodiments, the dual merge prediction mode is applied in an implicit way. For example, the dual merge prediction mode is proposed as one of merge candidates of merge prediction mode. When constructing the candidate list of a merge mode, for example, referring to merge list construction in ECM described before, a plurality of dual merge candidates is added to the candidate list. The plurality of dual merge candidates is derived from multiple neighboring blocks or the existing candidates in the candidate list.

In some embodiments, the plurality of dual merge candidates is derived from the existing candidates in the candidate list. After a merge candidate list is constructed, dual merge candidates are generated by pairing each two merge candidates in the merge candidate list, and then added to the candidate list.

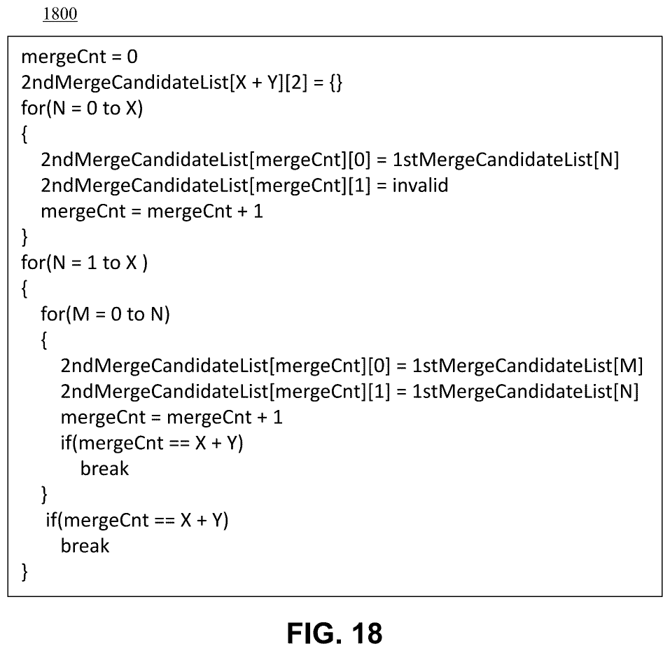

For example, a first candidate list is constructed by adding the candidates from spatial neighboring blocks, temporal collocated blocks, non-adjacent neighboring blocks, HMVP, CMVP, pairwise candidates, NLIC candidates, etc. Then, a second candidate list is constructed by copying the candidates in the first candidates list and adding dual merge candidates. In some embodiments, ARMC is applied to reorder the merge candidates in the first candidate list. FIG. 18 illustrates exemplary codes 1800 of pairing candidates to form dual merge candidates, according to some embodiments of the present disclosure, where:
1stMergeCandidateList is derived using the existing candidate list construction process of regular merge mode;
2ndMergeCandidateList is a list that contains candidates either have only one set of motion information or have two sets of motion information;
X is the number of merge candidates in the first candidate list;
Y is a pre-defined value that indicates the maximum number of dual merge candidates.

In some embodiments, the ARMC is applied to the second candidate list. The second candidate list is then used for the current block.

In some embodiments, the plurality of dual merge candidates is derived from neighboring blocks with a pre-defined pairing order, and these dual merge candidates are added to the candidate list of merge modes.

For example, when constructing a first candidate list for regular merge mode, three dual merge candidates are added after the pairwise candidates. Referring to FIG. 5, these three dual merge candidates are derived by pairing motion information of blocks located at {A0, B0}, {A1, B1} and {B2, A0}.

In some embodiments, the disclosed methods can be combined with other inter tools. The Template Matching (TM), Decoder side Motion Vector Refinement (DMVR), Bi-directional Optical Flow (BDOF), Local Illumination Compensation (LIC), Bi-predicted with CU-level Weight (BCW), Overlapped Block Motion Compensation (OBMC) can be applied with dual merge prediction mode.

In some embodiments, the template matching based motion vector refinement process is applied to the dual merge prediction mode. Each set of motion information is refined by the TM process separately, and the refined motion information is used to perform motion compensation.

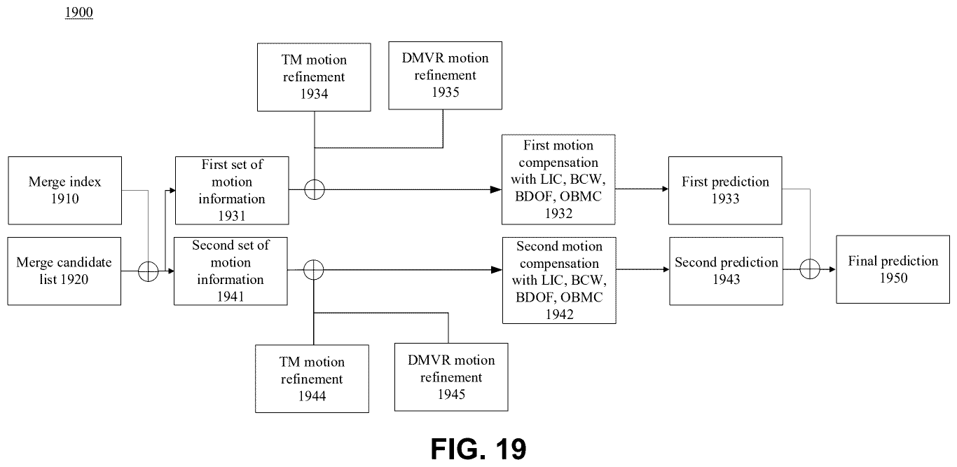

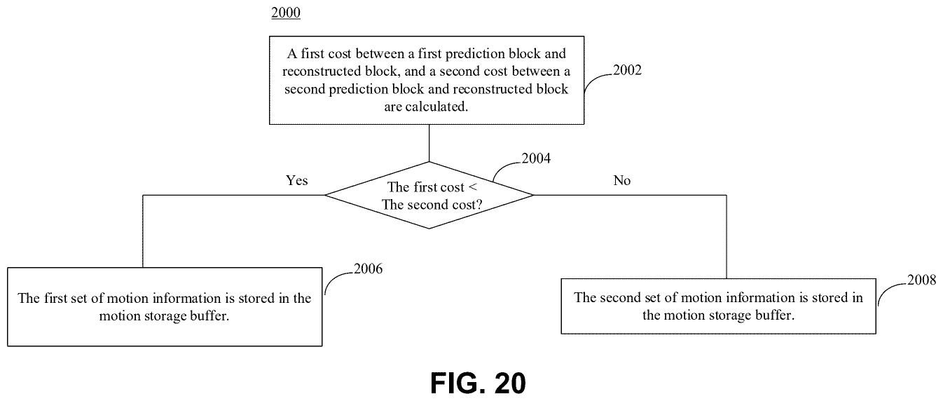

FIG. 19 is a schematic diagram illustrating an exemplary framework 1900 of combining dual merge prediction mode with other inter tools, according to some embodiments of the present disclosure. As shown in FIG. 19, an iterative TM refinement process can be applied to the dual merge prediction mode. The first set of motion information 1931 is firstly refined by the TM process 1934. Then, the template used in the TM process 1944 for second set of motion information 1941 is updated by considering first prediction 1933 obtained using the refined first set of motion information. Then, TM process 1944 is applied to the second set of motion information 1941 with the updated template. Again, the template is further updated by considering second prediction 1943 obtained using the refined second set of motion information. This update template is then used in the TM process 1934 to refine the refined first set of motion information. In some embodiments, as described above, the number of iterative TM refinement is 3, that is, the template can be updated third times. In some embodiments, the number of iterative TM refinement can be greater than 3, that is, the template can be updated more than three times, which depends on the user requirements and restrictions, and will not be limited herein.

In some embodiments, as shown in FIG. 19, DMVR process can be applied to each set of motion information to refine the motion information. For example, first set of motion information 1931 can be refined using DMVR process 1935, and second set of motion information 1941 can be refined using DMVR process 1945.

In some embodiments, as shown in FIG. 19, one or more of BDOF, BCW, LIC, OBMC processes can be applied during the motion compensation process. These processes are applied to each of prediction before weighting the two predictions together. For example, BDOF, BCW, LIC, or OBMC can be applied to first motion compensation 1932 and second motion compensation 1942 combined or separately. In some embodiments, two modes of BDOF, BCW, LIC, or OBMC can be applied. In some embodiments, three modes of BDOF, BCW, LIC, or OBMC can be applied. In some embodiments, all of the BDOF, BCW, LIC, and OBMC can be applied.

Description of other steps of framework 1900 can be found by referring to such description above with reference to FIG. 11 which will not repeat herein.

In some embodiments, motion information of dual merge prediction mode is stored. In some embodiments, motion information of each inter-coded block and motion information of dual merge prediction mode are stored at a 4×4 grid level. The motion information stored in a motion storage buffer is used to predict the motion information of the next inter coded block. For example, when constructing the merge candidate list, the motion information may be obtained from the motion storage buffer. In some embodiments, each 4×4 grid can only store one set of motion information.

In some embodiments, for a block coded in dual merge prediction mode, two sets of motion information are used to predict the current block, then both sets of motion information are stored. In some embodiments, the motion storage buffer is doubled, that is, a space for storing the motion information is doubled.

In some embodiments, for a skip or merge coded block, merge candidates may be obtained from a dual merge coded block. In this case, two sets of motion information are separately added to the candidate list and are treated as separate candidates.

In some embodiments, only one of the two sets of motion information for the dual merge prediction mode is stored in the motion storage buffer.

In some embodiments, the first set of motion information is always stored in the motion storage buffer.

In some embodiments, the second set of motion information is always stored in the motion storage buffer.

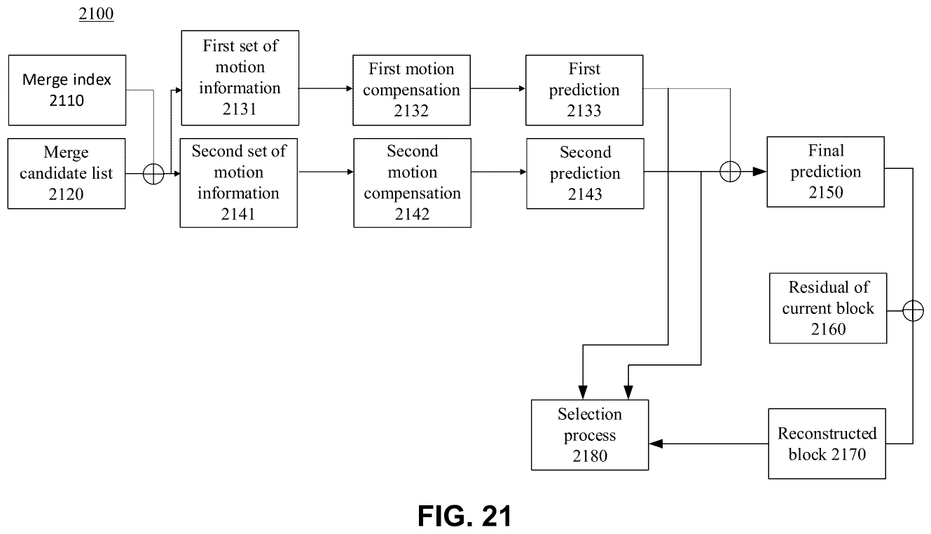

In some embodiments, a selection process is performed. FIG. 20 illustrates an example flow chart of a method 2000 for selectively storing motion information, according to some embodiments of the present disclosure. FIG. 21 is a schematic diagram illustrating an exemplary selection process of motion information storage, according to some embodiments of the present disclosure. Method 2000 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 2000. In some embodiments, method 2000 can be implemented by a computer program product, embodied in a computer-readable medium, including computer-executable instructions, such as program code, executed by computers (e.g., apparatus 400 of FIG. 4). Referring to FIG. 20 and FIG. 21, method 2000 may include the following steps 2002-2008.

At step 2002, a first cost (cost1) between a first prediction 2133 and a reconstructed block 2170, and a second cost (cost2) between a second prediction 2143 and reconstructed block 2170 are calculated by a selection process 2180. Reconstructed block 2170 is obtained based on final prediction 2150 and a residual 2160 of current block. The details for obtaining final prediction 2150 of the current block can refer to the description of framework 1100 in consistent with FIG. 11. In some embodiments, the sum of absolute difference (SAD) or sum of square error (SSE) may be used for the cost calculation.

At step 2004, the first cost and the second cost are compared by selection process 2180.

At step 2006, in response to the first cost being smaller than the second cost, the first set of motion information is stored in the motion storage buffer.

At step 2008, in response to the first cost being equal to or greater than the second cost, the second set of motion information is stored in the motion storage buffer.

In some embodiments, the two sets of motion information are averaged, and then the averaged motion information is stored in the motion storage buffer.

In some embodiments, a deblocking filter for dual merge prediction mode can be used. For example, if one side of samples for an edge is coded using the dual merge prediction mode, the boundary strength of the edge is directly set to a pre-defined value. In some embodiments, the pre-defined value may be 1 or 2.

The embodiments described in the present disclosure can be freely combined.

In some embodiments, a non-transitory computer readable medium storing a bitstream is provided. The bitstream is generated by receiving a video sequence and encoding the video sequence to generate coded information included in the bitstream. The bitstream can be transmitted to a decoder for decoding. The video sequence is encoded by the above-described methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:
1. A method for encoding a video sequence, the method comprising:
receiving a video sequence; and
encoding the video sequence by:
   constructing a merge candidate list for a current block;
   obtaining a first set of motion information and a second set of motion information from the merge candidate list;
   performing a first motion compensation and a second motion compensation with the first set of motion information and the second set of motion information respectively;
   generating a first prediction and a second prediction based on the first motion compensation and the second motion compensation respectively; and
   generating a final prediction of the current block by weighting the first prediction and the second prediction.
2. The method according to clause 1, wherein each merge candidate in the merge candidate list comprises one set of motion information, and obtaining the first set of motion information and the second set of motion information from the merge candidate list further comprises:
encoding a first merge index indicating a first merge candidate in the merge candidate list, motion information of the first merge candidate being the first set of motion information;
encoding a second merge index indicating a second merge candidate in the merge candidate list, motion information of the second merge candidate being the second set of motion information; wherein the first merge index is different from the second merge index.
3. The method according to clause 1, wherein the merge candidate list is a dual merge candidate list, each merge candidate in the dual merge candidate list comprising two sets of motion information, and obtaining the first set of motion information and the second set of motion information from the merge candidate list further comprises:
encoding a merge index indicating a merge candidate, the two sets of motion information of the merge candidate being the first set of motion information and the second set of motion information.
4. The method according to clause 3, wherein constructing the dual merge candidate list for the current block further comprises:
constructing a first candidate list, wherein each candidate in the first candidate list comprises a set of motion information;
obtaining dual merge candidates by pairing candidates in the first candidate list; and
constructing the dual merge candidate list by filling with dual merge candidates from neighboring blocks.
5. The method according to clause 4, further comprising:
adaptively reordering the candidates in the first candidate list with template matching.
6. The method according to clause 1, wherein the merge candidate list is a dual merge candidate list, each merge candidate in the dual merge candidate list comprising two sets of motion information, and constructing the dual merge candidate list for the current block further comprises:
constructing a first candidate list for regular merge mode; and
adding a plurality of dual merge candidates to the first candidate list to obtain the dual merge candidate list, the plurality of dual merge candidates derived from multiple neighboring blocks or existing candidates in the first candidate list.
7. The method according to clause 1, further comprising:
   refining the first set of motion information using template matching based motion vector refinement with a template;
   updating the template for the refinement considering a first prediction obtained by the refined first set of motion information; and
   refining the second set of motion information using template matching based motion vector refinement with the updated template.
8. The method according to clause 1, further comprising:
refining the first set of motion information and the second set of motion information using decoder side motion vector refinement (DMVR); and wherein performing the first motion compensation and the second motion compensation with the first set of motion information and the second set of motion information respectively further comprises:
performing the first motion compensation and the second motion compensation with one or more of bi-directional optical flow (BDOF), bi-predicted with CU-level weight (BCW), local illumination compensation (LIC), or overlapped block motion compensation (OBMC).
9. The method according to clause 1, further comprising:
storing the first set of motion information or the second set of motion information.
10. The method according to clause 9, wherein both of the first set of motion information and the second set of motion information are stored.
11. A method for decoding a bitstream, the method comprising:
receiving a bitstream; and
decoding the bitstream to output a video sequence, the decoding comprising:
   constructing a merge candidate list for a current block;
   obtaining a first set of motion information and a second set of motion information from the merge candidate list;
   performing a first motion compensation and a second motion compensation with the first set of motion information and the second set of motion information respectively;
   generating a first prediction and a second prediction based on the first motion compensation and the second motion compensation respectively; and
   generating a final prediction of the current block by weighting the first prediction and the second prediction.
12. The method according to clause 11, wherein each merge candidate in the merge candidate list comprises one set of motion information, and obtaining the first set of motion information and the second set of motion information from the merge candidate list further comprises:
decoding a first merge index indicating a first merge candidate in the merge candidate list, motion information of the first merge candidate being the first set of motion information;
decoding a second merge index indicating a second merge candidate in the merge candidate list, motion information of the second merge candidate being the second set of motion information; wherein the first merge index is different from the second merge index.
13. The method according to clause 11, wherein the merge candidate list is a dual merge candidate list, each merge candidate in the dual merge candidate list comprising two sets of motion information, and obtaining the first set of motion information and the second set of motion information from the merge candidate list further comprises:
decoding a merge index indicating a merge candidate, the two sets of motion information of the merge candidate being the first set of motion information and the second set of motion information.
14. The method according to clause 13, wherein constructing the dual merge candidate list for the current block further comprises:
constructing a first candidate list, wherein each candidate in the first candidate list comprises a set of motion information;
obtaining dual merge candidates by pairing candidates in the first candidate list; and
constructing the dual merge candidate list by filling with dual merge candidates from neighboring blocks.
15. The method according to clause 14, further comprising:
adaptively reordering the candidates in the first candidate list with template matching.
16. The method according to clause 11, wherein the merge candidate list is a dual merge candidate list, each merge candidate in the dual merge candidate list comprising two sets of motion information, and constructing the dual merge candidate list for the current block further comprises:
constructing a first candidate list for regular merge mode; and
adding a plurality of dual merge candidates to the first candidate list to obtain the dual merge candidate list, the plurality of dual merge candidates derived from multiple neighboring blocks or existing candidates in the first candidate list.
17. The method according to clause 11, further comprising:
   refining the first set of motion information using template matching based motion vector refinement with a template;
   updating the template for the refinement considering a first prediction obtained by the refined first set of motion information; and
   refining the second set of motion information using template matching based motion vector refinement with the updated template.
18. The method according to clause 11, further comprising:
refining the first set of motion information and the second set of motion information using decoder side motion vector refinement (DMVR); and wherein performing the first motion compensation and the second motion compensation with the first set of motion information and the second set of motion information respectively further comprises:
performing the first motion compensation and the second motion compensation with one or more of bi-directional optical flow (BDOF), bi-predicted with CU-level weight (BCW), local illumination compensation (LIC), or overlapped block motion compensation (OBMC).
19. The method according to clause 11, further comprising:
storing the first set of motion information or the second set of motion information.
20. The method according to clause 19, wherein both of the first set of motion information and the second set of motion information are stored.
21. A non-transitory computer readable medium storing a bitstream, the bitstream generated by receiving a video sequence, encoding the video sequence to generate coded information included in the bitstream, and transmit the bitstream, wherein the encoding comprises:
   signaling a first flag indicates whether dual merge mode is used for a current block
   constructing a merge candidate list for the current block;
   obtaining a first set of motion information and a second set of motion information from the merge candidate list;
   performing a first motion compensation and a second motion compensation with the first set of motion information and the second set of motion information respectively;
   generating a first prediction and a second prediction based on the first motion compensation and the second motion compensation respectively; and
   generating a final prediction of the current block by weighting the first prediction and the second prediction.
22. The non-transitory computer readable medium according to clause 21, wherein each merge candidate in the merge candidate list comprises one set of motion information, and obtaining the first set of motion information and the second set of motion information from the merge candidate list further comprises:
encoding a first merge index indicating a first merge candidate in the merge candidate list, motion information of the first merge candidate being the first set of motion information;
encoding a second merge index indicating a second merge candidate in the merge candidate list, motion information of the second merge candidate being the second set of motion information; wherein the first merge index is different from the second merge index.
23. The non-transitory computer readable medium according to clause 21, wherein the merge candidate list is a dual merge candidate list, each merge candidate in the dual merge candidate list comprising two sets of motion information, and obtaining the first set of motion information and the second set of motion information from the merge candidate list further comprises:
encoding a merge index indicating a merge candidate, the two sets of motion information of the merge candidate being the first set of motion information and the second set of motion information.
24. The non-transitory computer readable medium according to clause 13, wherein constructing the dual merge candidate list for the current block further comprises:
constructing a first candidate list, wherein each candidate in the first candidate list comprises a set of motion information;
obtaining dual merge candidates by pairing candidates in the first candidate list; and
constructing the dual merge candidate list by filling with dual merge candidates from neighboring blocks.
25. The non-transitory computer readable medium according to clause 24, the encoding further comprises:
adaptively reordering the candidates in the first candidate list with template matching.
26. The non-transitory computer readable medium according to clause 21, wherein the merge candidate list is a dual merge candidate list, each merge candidate in the dual merge candidate list comprising two sets of motion information, and constructing the dual merge candidate list for the current block further comprises:
constructing a first candidate list for regular merge mode; and
adding a plurality of dual merge candidates to the first candidate list to obtain the dual merge candidate list, the plurality of dual merge candidates derived from multiple neighboring blocks or existing candidates in the first candidate list.
27. The non-transitory computer readable medium according to clause 21, wherein the encoding further comprises:
   refining the first set of motion information using template matching based motion vector refinement with a template;
   updating the template for the refinement considering a first prediction obtained by the refined first set of motion information; and
   refining the second set of motion information using template matching based motion vector refinement with the updated template.
28. The non-transitory computer readable medium according to clause 21, wherein the encoding further comprises:
refining the first set of motion information and the second set of motion information using decoder side motion vector refinement (DMVR); and wherein performing the first motion compensation and the second motion compensation with the first set of motion information and the second set of motion information respectively further comprises:
performing the first motion compensation and the second motion compensation with one or more of bi-directional optical flow (BDOF), bi-predicted with CU-level weight (BCW), local illumination compensation (LIC), or overlapped block motion compensation (OBMC).
29. The non-transitory computer readable medium according to clause 21, wherein the encoding further comprises:
storing the first set of motion information or the second set of motion information.
30. The non-transitory computer readable medium according to clause 29, wherein both of the first set of motion information and the second set of motion information are stored.
31. A method for encoding a video sequence, the method comprising:
receiving a video sequence; and
encoding the video sequence by:
   determining whether a dual merge prediction mode is enabled for the video sequence at a high-level;
   in response the dual merge prediction mode is enabled at the high-level, determining whether the dual merge prediction mode is enabled at a coding unit (CU) level;
   in response to the dual merge prediction mode is enabled at the CU level, encoding the coding unit using the dual merge prediction mode; wherein encoding the coding unit using the dual merge prediction mode comprises:
      constructing a merge candidate list for a current block;
      obtaining a first set of motion information and a second set of motion information from the merge candidate list;
      performing a first motion compensation and a second motion compensation with the first set of motion information and the second set of motion information respectively;
      generating a first prediction and a second prediction based on the first motion compensation and the second motion compensation respectively; and
      generating a final prediction of the current block by fusing the first prediction and the second prediction.
32. The method according to clause 31, wherein determining whether the dual merge prediction mode is used for the video sequence at the high-level further comprises:
encoding a high-level flag indicating whether the dual merge prediction mode is enabled in a sequence parameter set (SPS), a picture parameter set (PPS), picture header, or slice header.
33. The method according to clause 31, wherein determining whether the dual merge prediction mode is used for the video sequence at the high-level further comprises:
determining whether the dual merge prediction mode is used for previous pictures in a same sequence; and
in response to a ratio the previous pictures coded using the dual merge prediction mode being greater than a threshold, enabling the dual merge prediction mode for a current picture or slice.
34. The method according to clause 31, wherein one sequence comprises multiple temporal layers, and determining whether the dual merge prediction mode is used for the video sequence at the high-level further comprises:
determining an index of a temporal layer of a current picture or slice; and
in response to the index of the temporal layer is less than a threshold, enabling the dual merge prediction mode for the current picture or slice.
35. A method for decoding a bitstream, the method comprising:
receiving a bitstream; and
decoding the bitstream to output a video sequence, the decoding comprising:
   determining whether a dual merge prediction mode is enabled for the video sequence at a high-level;
   in response the dual merge prediction mode is enabled at the high-level, determining whether the dual merge prediction mode is enabled at a coding unit (CU) level;
   in response to the dual merge prediction mode is enabled at the CU level, encoding the coding unit using the dual merge prediction mode; wherein encoding the coding unit using the dual merge prediction mode comprises:
      constructing a merge candidate list for a current block;
      obtaining a first set of motion information and a second set of motion information from the merge candidate list;
      performing a first motion compensation and a second motion compensation with the first set of motion information and the second set of motion information respectively;
      generating a first prediction and a second prediction based on the first motion compensation and the second motion compensation respectively; and
      generating a final prediction of the current block by fusing the first prediction and the second prediction.
36. The method according to clause 35, wherein determining whether the dual merge prediction mode is used for the video sequence at the high-level further comprises:
decoding a high-level flag indicating whether the dual merge prediction mode is enabled in a sequence parameter set (SPS), a picture parameter set (PPS), picture header, or slice header.
37. The method according to clause 35, wherein determining whether the dual merge prediction mode is used for the video sequence at the high-level further comprises:
determining whether the dual merge prediction mode is used for previous pictures in a same sequence; and
in response to a ratio the previous pictures coded using the dual merge prediction mode being greater than a threshold, enabling the dual merge prediction mode for a current picture or slice.
38. The method according to clause 35, wherein one sequence comprises multiple temporal layers, and determining whether the dual merge prediction mode is used for the video sequence at the high-level further comprises:
determining an index of a temporal layer of a current picture or slice; and
in response to the index of the temporal layer is less than a threshold, enabling the dual merge prediction mode for the current picture or slice.
39. A non-transitory computer readable medium storing a bitstream, the bitstream generated by receiving a video sequence, encoding the video sequence to generate coded information included in the bitstream, and transmit the bitstream, wherein the encoding comprises:
determining whether a dual merge prediction mode is enabled for the video sequence at a high-level;
   in response the dual merge prediction mode is enabled at the high-level, determining whether the dual merge prediction mode is enabled at a coding unit (CU) level;
   in response to the dual merge prediction mode is enabled at the CU level, encoding the coding unit using the dual merge prediction mode; wherein encoding the coding unit using the dual merge prediction mode comprises:
      constructing a merge candidate list for a current block;
      obtaining a first set of motion information and a second set of motion information from the merge candidate list;
      performing a first motion compensation and a second motion compensation with the first set of motion information and the second set of motion information respectively;
      generating a first prediction and a second prediction based on the first motion compensation and the second motion compensation respectively; and
      generating a final prediction of the current block by fusing the first prediction and the second prediction.
40. The non-transitory computer readable medium according to clause 39, wherein determining whether the dual merge prediction mode is used for the video sequence at the high-level further comprises:
encoding a high-level flag indicating whether the dual merge prediction mode is enabled in a sequence parameter set (SPS), a picture parameter set (PPS), picture header, or slice header.
41. The non-transitory computer readable medium according to clause 39, wherein determining whether the dual merge prediction mode is used for the video sequence at the high-level further comprises:
determining whether the dual merge prediction mode is used for previous pictures in a same sequence; and
in response to a ratio the previous pictures coded using the dual merge prediction mode being greater than a threshold, enabling the dual merge prediction mode for a current picture or slice.
42. The non-transitory computer readable medium according to clause 39, wherein one sequence comprises multiple temporal layers, and determining whether the dual merge prediction mode is used for the video sequence at the high-level further comprises:
determining an index of a temporal layer of a current picture or slice; and
in response to the index of the temporal layer is less than a threshold, enabling the dual merge prediction mode for the current picture or slice.
43. A method for encoding a video sequence, the method comprising:
receiving a video sequence; and
encoding the video sequence by:
   determining whether one side of a sample for an edge coded using a dual merge prediction mode;
   in response to one side of the sample for the edge coded using the dual merge prediction mode, setting a boundary strength of the edge to a pre-defined value.
44. The method according to clause 43, wherein the pre-defined value is 1 or 2.
45. A method for decoding a bitstream, the method comprising:
receiving a bitstream; and
decoding the bitstream to output a video sequence, the decoding comprising:
   determining whether one side of a sample for an edge coded using a dual merge prediction mode;
   in response to one side of the sample for the edge coded using the dual merge prediction mode, setting a boundary strength of the edge to a pre-defined value.
46. The method according to clause 45, wherein the pre-defined value is 1 or 2.
47. A non-transitory computer readable medium storing a bitstream, the bitstream generated by receiving a video sequence, encoding the video sequence to generate coded information included in the bitstream, and transmit the bitstream, wherein the encoding comprises:
determining whether one side of a sample for an edge coded using a dual merge prediction mode;
   in response to one side of the sample for the edge coded using the dual merge prediction mode, setting a boundary strength of the edge to a pre-defined value.
48. The non-transitory computer readable medium according to clause 47, wherein the pre-defined value is 1 or 2.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for encoding a video sequence, the method comprising:
receiving a video sequence; and
encoding the video sequence by:
constructing a merge candidate list for a current block;
obtaining a first set of motion information and a second set of motion information from the merge candidate list;
performing a first motion compensation and a second motion compensation with the first set of motion information and the second set of motion information respectively;
generating a first prediction and a second prediction based on the first motion compensation and the second motion compensation respectively; and
generating a final prediction of the current block by weighting the first prediction and the second prediction.

2. The method according to claim 1, wherein each merge candidate in the merge candidate list comprises one set of motion information, and obtaining the first set of motion information and the second set of motion information from the merge candidate list further comprises:
encoding a first merge index indicating a first merge candidate in the merge candidate list, motion information of the first merge candidate being the first set of motion information; and
encoding a second merge index indicating a second merge candidate in the merge candidate list, motion information of the second merge candidate being the second set of motion information; wherein the first merge index is different from the second merge index.

3. The method according to claim 1, wherein the merge candidate list is a dual merge candidate list, each merge candidate in the dual merge candidate list comprising two sets of motion information, and obtaining the first set of motion information and the second set of motion information from the merge candidate list further comprises:
encoding a merge index indicating a merge candidate, the two sets of motion information of the merge candidate being the first set of motion information and the second set of motion information.

4. The method according to claim 3, wherein constructing the dual merge candidate list for the current block further comprises:
constructing a first candidate list, wherein each candidate in the first candidate list comprises a set of motion information;
obtaining dual merge candidates by pairing candidates in the first candidate list; and
constructing the dual merge candidate list by filling with dual merge candidates from neighboring blocks.

5. The method according to claim 4, further comprising:
adaptively reordering the candidates in the first candidate list with template matching.

6. The method according to claim 1, wherein the merge candidate list is a dual merge candidate list, each merge candidate in the dual merge candidate list comprising two sets of motion information, and constructing the dual merge candidate list for the current block further comprises:
constructing a first candidate list for regular merge mode; and
adding a plurality of dual merge candidates to the first candidate list to obtain the dual merge candidate list, the plurality of dual merge candidates derived from multiple neighboring blocks or existing candidates in the first candidate list.

7. The method according to claim 1, further comprising:
refining the first set of motion information using template matching based motion vector refinement with a template;
updating the template for the refinement considering a first prediction obtained by the refined first set of motion information; and
refining the second set of motion information using template matching based motion vector refinement with the updated template.

8. A method for decoding a bitstream, the method comprising:
receiving a bitstream; and
decoding the bitstream to output a video sequence, the decoding comprising:
constructing a merge candidate list for a current block;
obtaining a first set of motion information and a second set of motion information from the merge candidate list;
performing a first motion compensation and a second motion compensation with the first set of motion information and the second set of motion information respectively;
generating a first prediction and a second prediction based on the first motion compensation and the second motion compensation respectively; and
generating a final prediction of the current block by weighting the first prediction and the second prediction.

9. The method according to claim 8, wherein each merge candidate in the merge candidate list comprises one set of motion information, and obtaining the first set of motion information and the second set of motion information from the merge candidate list further comprises:
decoding a first merge index indicating a first merge candidate in the merge candidate list, motion information of the first merge candidate being the first set of motion information; and
decoding a second merge index indicating a second merge candidate in the merge candidate list, motion information of the second merge candidate being the second set of motion information; wherein the first merge index is different from the second merge index.

10. The method according to claim 8, wherein the merge candidate list is a dual merge candidate list, each merge candidate in the dual merge candidate list comprising two sets of motion information, and obtaining the first set of motion information and the second set of motion information from the merge candidate list further comprises:
decoding a merge index indicating a merge candidate, the two sets of motion information of the merge candidate being the first set of motion information and the second set of motion information.

11. The method according to claim 10, wherein constructing the dual merge candidate list for the current block further comprises:
constructing a first candidate list, wherein each candidate in the first candidate list comprises a set of motion information;
obtaining dual merge candidates by pairing candidates in the first candidate list; and
constructing the dual merge candidate list by filling with dual merge candidates from neighboring blocks.

12. The method according to claim 11, further comprising:
adaptively reordering the candidates in the first candidate list with template matching.

13. The method according to claim 8, wherein the merge candidate list is a dual merge candidate list, each merge candidate in the dual merge candidate list comprising two sets of motion information, and constructing the dual merge candidate list for the current block further comprises:
constructing a first candidate list for regular merge mode; and
adding a plurality of dual merge candidates to the first candidate list to obtain the dual merge candidate list, the plurality of dual merge candidates derived from multiple neighboring blocks or existing candidates in the first candidate list.

14. The method according to claim 8, further comprising:
refining the first set of motion information using template matching based motion vector refinement with a template;
updating the template for the refinement considering a first prediction obtained by the refined first set of motion information; and
refining the second set of motion information using template matching based motion vector refinement with the updated template.

15. A non-transitory computer readable medium storing a bitstream, the bitstream generated by receiving a video sequence, encoding the video sequence to generate coded information included in the bitstream, and transmit the bitstream, wherein the encoding comprises:
signaling a first flag indicates whether dual merge mode is used for a current block;
constructing a merge candidate list for the current block;
obtaining a first set of motion information and a second set of motion information from the merge candidate list;
performing a first motion compensation and a second motion compensation with the first set of motion information and the second set of motion information respectively;
generating a first prediction and a second prediction based on the first motion compensation and the second motion compensation respectively; and
generating a final prediction of the current block by weighting the first prediction and the second prediction.

16. The non-transitory computer readable medium according to claim 15, wherein each merge candidate in the merge candidate list comprises one set of motion information, and obtaining the first set of motion information and the second set of motion information from the merge candidate list further comprises:
encoding a first merge index indicating a first merge candidate in the merge candidate list, motion information of the first merge candidate being the first set of motion information;
encoding a second merge index indicating a second merge candidate in the merge candidate list, motion information of the second merge candidate being the second set of motion information; wherein the first merge index is different from the second merge index.

17. The non-transitory computer readable medium according to claim 15, wherein the merge candidate list is a dual merge candidate list, each merge candidate in the dual merge candidate list comprising two sets of motion information, and obtaining the first set of motion information and the second set of motion information from the merge candidate list further comprises:
encoding a merge index indicating a merge candidate, the two sets of motion information of the merge candidate being the first set of motion information and the second set of motion information.

18. The non-transitory computer readable medium according to claim 17, wherein constructing the dual merge candidate list for the current block further comprises:
constructing a first candidate list, wherein each candidate in the first candidate list comprises a set of motion information;
obtaining dual merge candidates by pairing candidates in the first candidate list; and
constructing the dual merge candidate list by filling with dual merge candidates from neighboring blocks.

19. The non-transitory computer readable medium according to claim 15, wherein the merge candidate list is a dual merge candidate list, each merge candidate in the dual merge candidate list comprising two sets of motion information, and constructing the dual merge candidate list for the current block further comprises:
constructing a first candidate list for regular merge mode; and
adding a plurality of dual merge candidates to the first candidate list to obtain the dual merge candidate list, the plurality of dual merge candidates derived from multiple neighboring blocks or existing candidates in the first candidate list.

20. The non-transitory computer readable medium according to claim 15, wherein the encoding further comprises:
refining the first set of motion information using template matching based motion vector refinement with a template;
updating the template for the refinement considering a first prediction obtained by the refined first set of motion information; and
refining the second set of motion information using template matching based motion vector refinement with the updated template.
